(19) United States
(12) Patent Application Publication
(10) Pub. No.: US 2003/0021284 A1
(43) Pub. Date: Jan. 30, 2003

(54) Coordinate input apparatus including an optical movement detection device used for optically inputting coordinates and pressed for switching a switch device

(76) Inventors: Junichi Iwasaki, Sano-Shi (JP); Yasuo Yokoo, Sano-Shi (JP)

Correspondence Address: LADAS & PARRY, 224 SOUTH MICHIGAN AVENUE, SUITE 1200, CHICAGO, IL, 60604, US

(21) Appl. No.: 10/153,082

(22) Filed: May 22, 2002

(30) Foreign Application Priority Data
Jul. 26, 2001 (JP) 2001-225991

(51) Int. Cl. H04L 12/28; H04L 12/56

(52) U.S. Cl. 370/411

(57) ABSTRACT

This coordinate input apparatus comprises an optical movement detection device and a switch device. The optical movement detection device projects a light on a detection object moving on an input portion, and receives the light reflected from the detection object so as to generate a move signal according to the light reflected from the detection object. The move signal includes moving direction information and moving distance information of the detection object. The switch device switches on and off by the optical movement detection device being displaced by the input portion being pressed.

### BACKGROUND OF THE INVENTION

1. Field of the Invention

The present invention generally relates to a coordinate input apparatus, and more particularly, to a coordinate input apparatus used in a portable phone and other portable information apparatuses used for inputting and outputting variety of information.

2. Description of the Related Art

Recent progresses in IT (information technology) and communications technology have been providing multifunctional portable phones. A portable phone of this kind has various communications functions in addition to an ordinary telephone function. Therefor, the portable phone is provided with a liquid crystal display as an output device, and various switches as input devices.

One of these various switches as input devices is a coordinate input apparatus used for moving a cursor displayed on the liquid crystal display. Conventionally, a four-way operational switch has been used as the coordinate input apparatus.

This four-way operational switch has a structure in which an operation button (a key top) can be moved up, down, left and right. According to the movement of this operation button, the cursor displayed on the liquid crystal display also moves up, down, left and right.

Additionally, the four-way operational switch also functions as a decision switch. Specifically, the four-way operational switch can be used to switch on/off by pressing a central portion of the operation button toward a body of the portable phone. Accordingly, the cursor is moved to a position indicating a desired functional display by operating the operation button up, down, left and/or right, and a decision switch can be selected at this point by pressing the operation button.

The four-way operational switch used as the conventional coordinate input apparatus comprises a membrane switch including five electric-switch contact points, the operation button provided on this membrane switch, and a supporting mechanism supporting this operation button movably such that the operation button can move up, down, left and right, and also in a pressing direction toward the body of the portable phone.

However, since the conventional coordinate input apparatus is required to have the structure in which the operation button is movable in the four directions of up, down, left and right, the supporting mechanism comes to have a complicated structure, which disadvantageously makes the coordinate input apparatus large in height and size.

Additionally, in the conventional coordinate input apparatus, upon operating the operation button, the electric-switch contact points formed on the membrane switch can be pressed so as to be turned on. Therefor, the coordinate input apparatus needs to be provided with a space corresponding to an amount by which the operation button moves. This also makes the coordinate input apparatus large in height and size.

Further, in the conventional coordinate input apparatus using the electric-switch contact points, as the operation button is pressed again and again, the electric-switch contact points may possibly be worn away. Accordingly, the coordinate input apparatus becomes less reliable with time.

### SUMMARY OF THE INVENTION

It is a general object of the present invention to provide an improved and useful coordinate input apparatus and a portable phone in which the above-mentioned problems are eliminated.

A more specific object of the present invention is to provide a coordinate input apparatus and a portable phone which can be made small in height and size while being highly reliable.

In order to achieve the above-mentioned objects, there is provided according to one aspect of the present invention a coordinate input apparatus comprising:

an optical movement detection device projecting a light on a detection object moving on an input portion, and receiving the light reflected from the detection object so as to generate a move signal according to the light reflected from the detection object, the move signal including moving direction information and moving distance information of the detection object; and

a switch device switching on and off by the optical movement detection device being displaced by the input portion being pressed.

According to the present invention, the optical movement detection device detects a movement of the detection object so as to generate the move signal including moving direction information and moving distance information of the detection object; therefore, coordinates can be input by moving the detection object. In this course, since the moving direction and the moving distance of the detection object are detected by using a light, the coordinate input apparatus can be thinned down, compared to a configuration using an electric contact switch.

In addition, the switch device switches on/off by pressing/releasing the input portion. Thus, the one coordinate input apparatus can have the functions of inputting coordinates by moving the detection object and of switching on/off by pressing/releasing the input portion. Hence, the coordinate input apparatus can be made multifunctional and small.

Additionally, in the coordinate input apparatus according to the present invention, the optical movement detection device and the switch device may be formed on a same surface of a flexible substrate, and

the flexible substrate may be folded at a position between the optical movement detection device and the switch device so that the optical movement detection device and the switch device face outward respectively, and oppose each other with the flexible substrate therebetween.

According to the present invention, since the optical movement detection device and the switch device are provided on the same surface of the flexible substrate, the coordinate input apparatus can be assembled with ease. Additionally, since the flexible substrate also functions as a wiring used for connecting each device with external apparatuses, leading wires need not be connected to each device, apart from the flexible substrate. This decreases a number of components, and reduces manufacturing costs.

More specifically, the optical movement detection device and the switch device need to be arranged opposite each other (vertically). One of conceivable methods for realizing this arrangement is providing the optical movement detection device on the upper surface of the substrate and the switch device on the back surface of the substrate. However, this method makes the assembling process bothersome, because the devices have to be provided on the upper and back surfaces, respectively. However, using the flexible substrate enables the devices to be positioned opposite each other simply by folding the flexible substrate, even when the devices are provided on the same surface of the flexible substrate.

Additionally, in the coordinate input apparatus according to the present invention, the switch device may comprise:

a switch member provided in a vicinity of a bottom surface of the optical movement detection device;

a contact-point member provided opposite electrodes formed on the switch member, the contact-point member being elastically transformable between a first position contacting the electrodes and a second position away from the electrodes; and

a pressing member provided at a position opposing the contact-point member so as to engage the contact-point member and press the contact-point member toward the first position when the optical movement detection device is displaced.

According to the present invention, the one coordinate input apparatus can have the functions of inputting coordinates by moving the detection object and of switching on/off by pressing/releasing the input portion. Hence, the coordinate input apparatus can be made multifunctional and small.

Additionally, in the coordinate input apparatus according to the present invention, the optical movement detection device may comprise:

a light source emitting a light;

a sensor unit receiving the light reflected from the detection object so as to generate the move signal; and

an optical unit projecting the light emitted from the light source on the detection object moving on the input portion, and leading the light reflected from the detection object to the sensor unit.

According to the present invention, since the moving direction and the moving distance of the detection object are detected by using a light, the coordinate input apparatus can be thinned down, compared to a conventional coordinate input apparatus using an electric contact switch.

Additionally, the coordinate input apparatus according to the present invention may further comprise:

a first member accommodating the input portion such that the input portion is exposed outwardly; and

a second member provided opposite the first member,

wherein the optical movement detection device and the switch device are provided between the first member and the second member, and the optical movement detection device is provided movably on one of the first member and the second member.

According to the present invention, the optical movement detection device and the switch device are provided between the first member and the second member composing a housing of an apparatus normally incorporating a coordinate input apparatus, and the optical movement detection device is provided movably on one of the first member and the second member (of the housing). Therefore, a member movably supporting the optical movement detection device does not have to be provided additionally; thus, an apparatus normally incorporating the coordinate input apparatus can be miniaturized.

Additionally, the coordinate input apparatus according to the present invention may further comprise:

a first member accommodating the input portion such that the input portion is exposed outwardly;

a second member provided opposite the first member so that the optical movement detection device and the switch device are provided between the first member and the second member, the second member having a circuit substrate provided thereon; and

a supporting mechanism provided on at least one of the second member and the circuit substrate so as to movably support the optical movement detection device.

According to the present invention, the optical movement detection device and the switch device are provided between the first member and the second member composing a housing of an apparatus normally incorporating a coordinate input apparatus, and the optical movement detection device is movably supported by the supporting mechanism provided on at least one of the second member and the circuit substrate.

In order to achieve the above-mentioned objects, there is also provided according to another aspect of the present invention a portable phone communicating by wireless, the portable phone comprising the above-mentioned coordinate input apparatus.

According to the present invention, since the above-mentioned coordinate input apparatus is thinned down, the portable phone can also be thinned down.

Other objects, features and advantages of the present invention will become more apparent from the following detailed description when read in conjunction with the accompanying drawings.

### BRIEF DESCRIPTION OF THE DRAWINGS

FIG. 1 is a perspective view of a coordinate input apparatus according to a first embodiment of the present invention;

FIG. 2A and FIG. 2B are exploded perspective views of the coordinate input apparatus according to the first embodiment of the present invention;

FIG. 3 is a plan view of the coordinate input apparatus according to the first embodiment of the present invention;

FIG. 4 is a front view of the coordinate input apparatus according to the first embodiment of the present invention;

FIG. 5 is a sectional view taken along a line V-V in FIG. 3;

FIG. 6 is a perspective view of a portable phone including the coordinate input apparatus according to the first embodiment of the present invention;

FIG. 7 shows a block diagram of an electric circuit of the coordinate input apparatus according to the first embodiment of the present invention;

FIG. 8 is a plan view of a coordinate input apparatus according to a second embodiment of the present invention;

FIG. 9 is a front view of the coordinate input apparatus according to the second embodiment of the present invention;

FIG. 10 is a sectional view taken along a line X-X in FIG. 8;

FIG. 11 is a plan view of a coordinate input apparatus according to a third embodiment of the present invention;

FIG. 12 is a front view of the coordinate input apparatus according to the third embodiment of the present invention;

FIG. 13 is a sectional view taken along a line XIII-XIII in FIG. 11;

FIG. 14 is a sectional view of a coordinate input apparatus as a variation of the third embodiment of the present invention;

FIG. 15 is a front view of a coordinate input apparatus according to a fourth embodiment of the present invention;

FIG. 16 is a perspective view of a flexible substrate provided in the coordinate input apparatus according to the fourth embodiment of the present invention; and

FIG. 17 is a perspective view of the folded flexible substrate provided in the coordinate input apparatus according to the fourth embodiment of the present invention.

### DETAILED DESCRIPTION OF THE PREFERRED EMBODIMENTS

A description will now be given, with reference to the drawings, of embodiments according to the present invention.

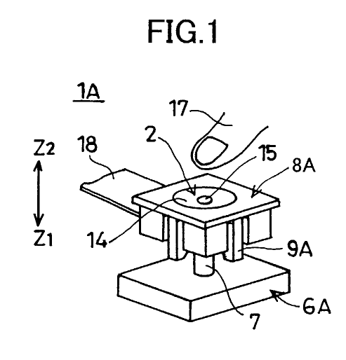

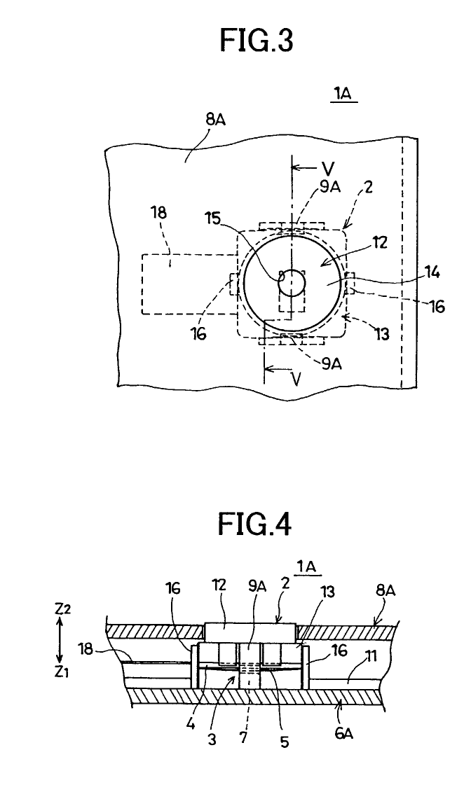

FIG. 1 to FIG. 5 illustrate a coordinate input apparatus 1A according to a first embodiment of the present invention. FIG. 6 illustrates a portable phone 25 using the coordinate input apparatus 1A. The portable phone 25 functions not only as an ordinary phone, but also as a portable information terminal inputting and outputting variety of information.

As shown in FIG. 6, the portable phone 25 has a configuration in which a liquid crystal display 27, operation buttons 28, a speaker 29, a microphone 30, an antenna 31 and other components are provided in a housing 26 composed of a top cover 8A (a first member) and a bottom case 6A (a second member). The coordinate input apparatus 1A is arranged at a substantially central position of the housing 26.

The coordinate input apparatus 1A exhibits a function of detecting a movement of a finger (a detection object) 17 moved by a user on an input portion 12, as described hereinafter, so as to move a cursor displayed on the liquid crystal display 27. In other words, the coordinate input apparatus 1A functions as a pointing device used for moving the cursor to an intended position on the liquid crystal display 27. The coordinate input apparatus 1A functions also as a decision switch upon pressing the input portion 12.

The coordinate input apparatus 1A having the above-mentioned functions chiefly comprises an optical movement detection device 2 and a switch device 3.

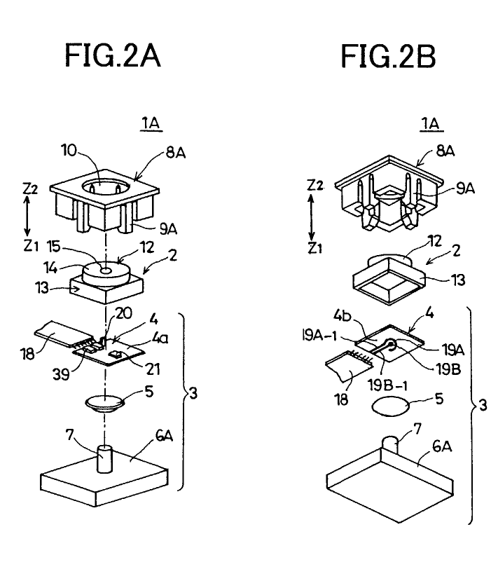

The optical movement detection device 2 comprises the input portion 12 and a body portion 13. This optical movement detection device 2 is mounted to the top cover 8A. It is noted that the top cover 8A is briefly depicted in a small blocky form in FIG. 1, FIG. 2A and FIG. 2B so as to facilitate an understanding of the structure.

The top cover 8A has an opening 10 so formed that the input portion 12 is positioned inside the opening 10 when the optical movement detection device 2 is mounted to the top cover 8A. The top cover 8A also has locking levers 9A extending toward direction Z1 in the figures. The body portion 13 engages these locking levers 9A.

Thus, the body portion 13 engages these locking levers 9A so that the optical movement detection device 2 is provided between the bottom case 6A and the top cover 8A, and is prevented from being separated from the top cover 8A. Further, in the state where the optical movement detection device 2 is mounted to the top cover 8A, the optical movement detection device 2 is movable slightly with respect to the top cover 8A in directions Z1 and Z2 in the figures.

However, when the optical movement detection device 2 is movably mounted as described above by the body portion 13 engaging hook portions formed at tips of the locking levers 9A, the optical movement detection device 2 will not be detached from the top cover 8A. Thus, in the present embodiment, since the optical movement detection device 2 is movably supported by the locking levers 9A formed on the top cover 8A, a supporting mechanism does not have to be separately provided on the top cover 8A; therefore, the coordinate input apparatus 1A can be miniaturized and thinned down.

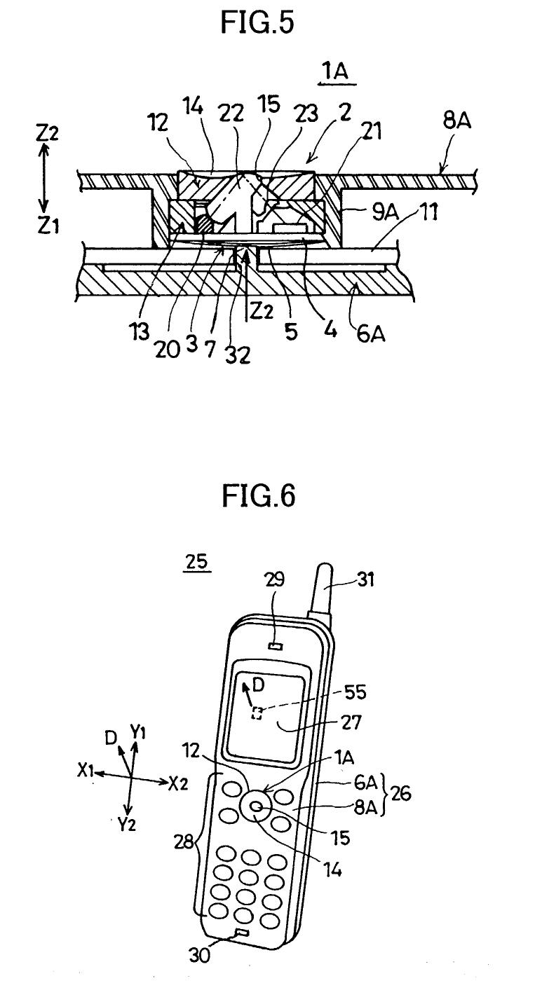

Next, a description will be given, with reference mainly to FIG. 2A, FIG. 2B and FIG. 5, of the inner structure of the optical movement detection device 2. The input portion 12 has a concave spherical portion 14 having a curvature so determined as to correspond to a shape of the finger 17. An input-output hole 15 is formed at a central position of the concave spherical portion 14. An upper end of a first optical lens 22 is exposed from the input-output hole 15.

The body portion 13 is arranged below the input portion 12. A double-sided substrate 4 is provided in an opening formed at a bottom part of the body portion 13. This double-sided substrate 4 is a double-sided printed substrate made of glass-epoxy. A light-emitting diode (a light source) 20, a sensor 21 and other electronic components 39 are provided on a surface 4a of the double-sided substrate 4.

On a back surface 4b of the double-sided substrate 4 are formed switch electrodes 19A and 19B composing a switch member of the switch device 3. These switch electrodes 19A and 19B are formed at a substantially central position of the back surface 4b.

Further, a flexible substrate 18 is connected to the double-sided substrate 4. Via this flexible substrate 18, the optical movement detection device 2 conducts an exchange of signals and a supply of electricity with an external device (such as other devices used for moving the cursor).

As mentioned above, the optical movement detection device 2 is movable slightly with respect to the top cover 8A in directions Z1 and Z2 in the figures. The flexible substrate 18 is also movable in accordance with the movement of the optical movement detection device 2. Therefore, even when the optical movement detection device 2 is movably mounted to the top cover 8A, the optical movement detection device 2 can surely conduct an exchange of signals and a supply of electricity with an external device.

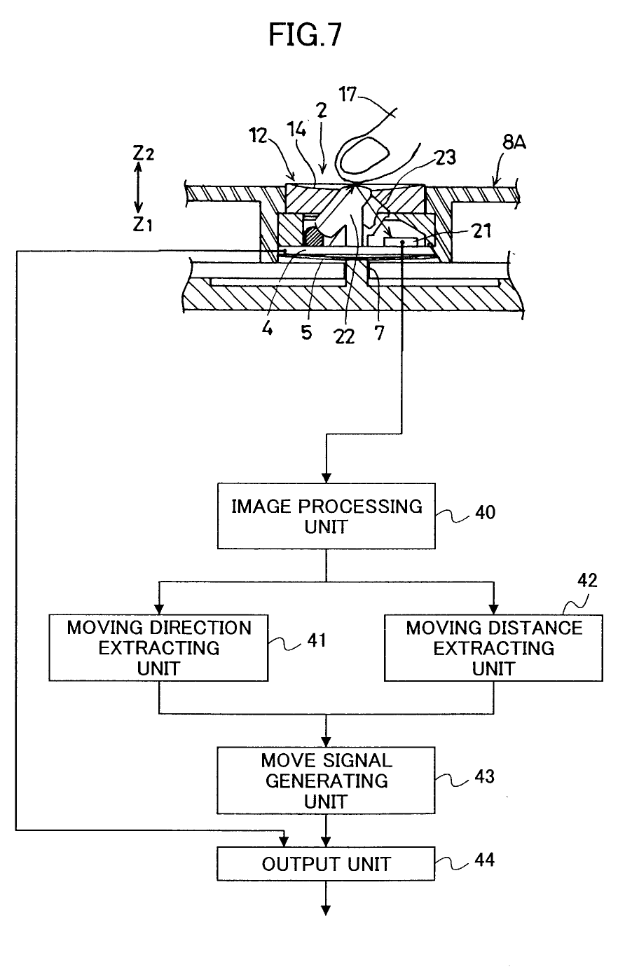

A lower oblique end of the first optical lens 22 faces the light-emitting diode 20. The upper end of the first optical lens 22 is exposed at the central position of the concave spherical portion 14, as described above. A light emitted from the light-emitting diode 20 is passed through inside of the first optical lens 22, and is projected from the input-output hole 15 onto the finger 17 (see FIG. 1 and FIG. 7).

The light is reflected on the finger 17, and is projected via a second optical lens 23 onto the sensor 21. The sensor 21 is a CCD element (a solid-state image sensing element), which photoelectrically converts the incident light into an image signal representing the finger 17, and outputs the image signal. Besides, the first optical lens 22 and the second optical lens 23 constitute an optical unit.

In the heretofore-described arrangement, moving the finger 17 on the input portion 12 varies conditions of the light reflected on the finger 17, which in turn varies the image signal output by the sensor 21. In the present embodiment, a move signal causing the cursor to move is generated based on the image signal output by the sensor 21.

Accordingly, the cursor can be moved by moving the finger 17 on the input portion 12, without pressing the operation button as required conventionally. More specifically, with reference to FIG. 6, moving the finger 17 on the coordinate input apparatus 1A (the input-output hole 15) in direction X1 in the figure causes a cursor 55 to move in direction X1 on the liquid crystal display 27. Similarly, moving the finger 17 in direction X2, Y1 or Y2 in the figure causes the cursor 55 to move in direction X2, Y1 or Y2 on the liquid crystal display 27.

Next, a description will be given of a process of generating the move signal from the image signal output from the sensor 21. The above-mentioned flexible substrate 18 is connected to a move signal generation device generating the move signal. At least the sensor 21 and the move signal generation device compose a sensor unit.

FIG. 7 shows a block diagram of a configuration of the move signal generation device. As shown in FIG. 7, the move signal generation device comprises an image processing unit 40, a moving direction extracting unit 41, a moving distance extracting unit 42, a move signal generating unit 43, and an output unit 44. The image processing unit 40 generates image data from the image signal of the finger 17 supplied from the sensor 21, and performs processes of extracting an outline and a fingerprint of the finger 17 by performing a binarization process and various corrections to the image data.

The image data generated by the image processing unit 40 is transmitted to the moving direction extracting unit 41 and the moving distance extracting unit 42. In this course, the image data is transmitted from the image processing unit 40 to the moving direction extracting unit 41 and the moving distance extracting unit 42 at a predetermined cycle.

The moving direction extracting unit 41 and the moving distance extracting unit 42 can store the image data transmitted last time. Each of the moving direction extracting unit 41 and the moving distance extracting unit 42 compares the image data transmitted last time with the image data transmitted this time. According to a change therebetween, the moving direction extracting unit 41 calculates the moving direction of the finger 17, and the moving distance extracting unit 42 calculates the moving distance of the finger 17.

The moving direction of the finger 17 calculated by the moving direction extracting unit 41 and the moving distance of the finger 17 calculated by the moving distance extracting unit 42 are transmitted to the move signal generating unit 43. Based on the moving direction and the moving distance of the finger 17, the move signal generating unit 43 generates the move signal causing the cursor to move. The move signal is output from the output unit 44 to a cursor movement control circuit (not shown in the figures) causing the cursor 55 to move. Thereby, the cursor 55 moves on the liquid crystal display 27 in a direction corresponding to the moving direction of the finger 17.

As described above, with the coordinate input apparatus 1A according to the present embodiment, the cursor 55 can be moved, not by pressing the operation button by the finger 17, but by moving the finger 17 on the optical movement detection device 2. Hence, the cursor 55 can be moved with an excellent operationality.

Additionally, since a conventional coordinate input apparatus has used a four-direction switch, moving directions of a cursor have been restricted to four directions X1, X2, Y1 and Y2 shown in FIG. 6. However, the present embodiment utilizes optical means and image process technology as described above so as to move the cursor 15 in any direction. Specifically, the cursor 15 can be moved also in direction D other than directions X1, X2, Y1 and Y2, as shown in FIG. 6.

Next, a description will be given of the switch device 3.

The switch device 3 is a switch provided for the purpose of causing the coordinate input apparatus 1A to function also as the decision switch upon pressing the input portion 12. The switch device 3 comprises the double-sided substrate 4, a contact-point member 5 and the bottom case 6A.

As described above, whereas the light-emitting diode 20, the sensor 21 and other electronic components 39 are provided on the surface 4a of the double-sided substrate 4, the switch electrodes 19A and 19B are formed on the back surface 4b of the double-sided substrate 4 (as shown in FIG. 2). These switch electrodes 19A and 19B are formed on the back surface 4b by being patterned thereon.

The contact-point member 5 has a substantially domical shape, and is formed of a conductive metal. A springy material is selected as the conductive metal forming the contact-point member 5 so that the contact-point member 5 is flexibly transformable.

The contact-point member 5 is fixed to the double-sided substrate 4 such that the contact-point member 5 faces the switch electrodes 19A and 19B. The contact-point member 5 is transformed flexibly toward the switch electrodes 19A and 19B so as to contact both the switch electrodes 19A and 19B; thereby, the switch device 3 turns on.

Besides, when the contact-point member 5 is fixed to the double-sided substrate 4, an insulating member is provided therebetween so that outer peripheral parts of the contact-point member 5 and leading wires 19A-1 and 19B-1 of the switch electrodes 19A and 19B do not short-circuit.

A projecting portion (a pressing member) 7 is formed upright on the bottom case 6A at a position opposing the contact-point member 5. Specifically, a flexible substrate 11 used for other circuits is provided on the bottom case 6A (see FIG. 4 and FIG. 5), and the projecting portion 7 is formed upright so as to pass through a through hole 32 formed in the flexible substrate 11 and face the contact-point member 5. The above-mentioned contact-point member 5 is transformed flexibly by being pressed by this projecting portion 7 so as to connect the switch electrodes 19A and 19B, turning on the switch device 3.

As shown in FIG. 5, in a state where the coordinate input apparatus 1A is assembled, the switch electrodes 19A and 19B, the contact-point member 5 and the projecting portion 7 are aligned in a substantially straight line. Additionally, the optical movement detection device 2 is continuously pressed by an elastic force of the contact-point member 5 at a position (hereinafter referred to as a second position) energized in direction Z2 in the figure.

As described above, the optical movement detection device 2 is movable with respect to the top cover 8A in directions Z1 and Z2 in the figures. Accordingly, in the state shown in FIG. 5, when the optical movement detection device 2 is pressed by the finger 17 in direction Z1, the optical movement detection device 2 moves in direction Z1 (to a position hereinafter referred to as a first position) against the elastic force of the contact-point member 5.

As the optical movement detection device 2 thus moves, the contact-point member 5 provided on the double-sided substrate 4 also moves in direction Z1; accordingly, the contact-point member 5 is pressed by the projecting portion 7 in direction Z2. By this pressing force, the contact-point member 5 is transformed flexibly toward the double-sided substrate 4, and is finally brought into electrical connection with the switch electrodes 19A and 19B. Thereby, the switch device 3 turns on.

Then, when the finger 17 stops pressing the optical movement detection device 2, the contact-point member 5 returns to its original state by its elastic restoration force. Accordingly, the optical movement detection device 2 moves in direction Z2. Thereby, the switch device 3 turns off, with the optical movement detection device 2 being in the state shown in FIG. 5.

As described above, in the coordinate input apparatus 1A according to the present embodiment, the optical movement detection device 2 detects a movement of the finger 17, and generates the move signal including the moving direction information and the moving distance information of the finger 17. Thus, coordinates can be input by moving the finger 17. In this course, since the moving direction and the moving distance of the finger 17 are detected by using a light, the coordinate input apparatus 1A can be thinned down, compared to a conventional configuration using an electric contact switch. Accordingly, the portable phone 25 including the coordinate input apparatus 1A can be also thinned down.

Additionally, the switch device 3 turns on/off by pressing/releasing the input portion 12. Thus, the coordinate input apparatus 1A can have two functions for inputting coordinates by moving the finger 17 and for switching by pressing the input portion 12. Hence, the coordinate input apparatus 1A can be multifunctional. Further, since the above-mentioned two functions can be performed by operating the input portion 12 alone, the coordinate input apparatus 1A can be made compact and small.

Next, a description will be given of a second embodiment according to the present invention.

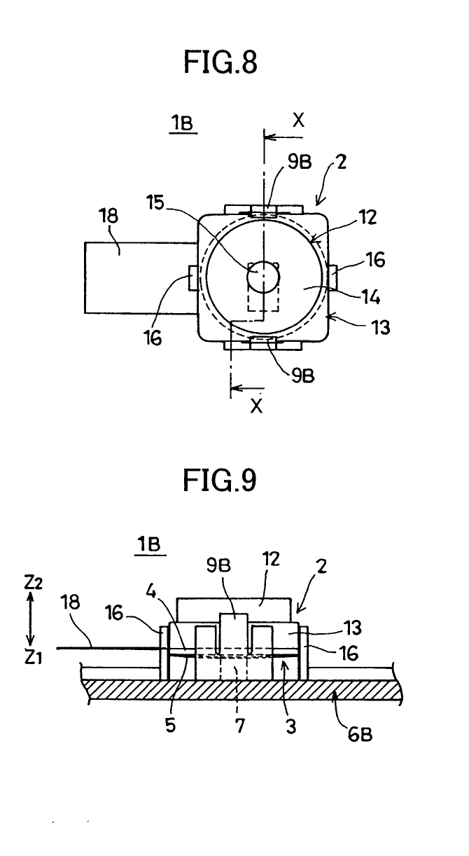

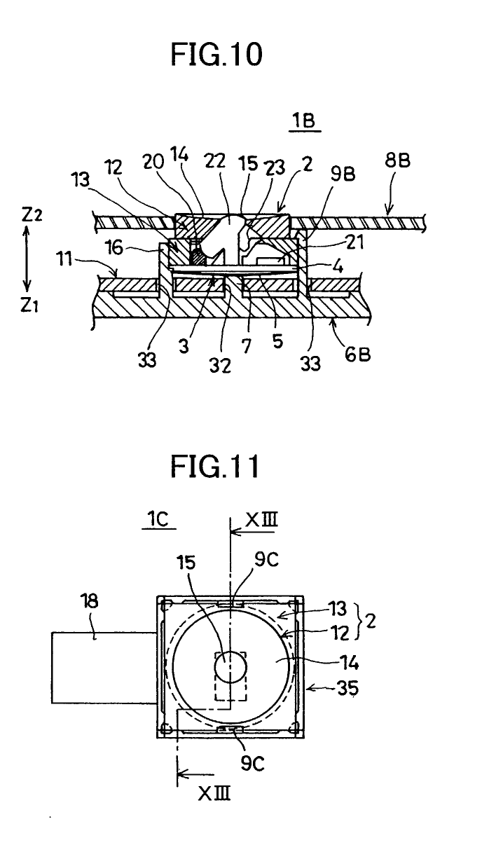

FIG. 8 to FIG. 10 illustrate a coordinate input apparatus 1B according to the second embodiment of the present invention. Elements in FIG. 8 to FIG. 10 that are identical or equivalent to the elements shown in FIG. 1 to FIG. 7 illustrating the coordinate input apparatus 1A according to the foregoing first embodiment are referenced by the same reference marks, and will not be described in detail. The same applies to other embodiments described hereinafter.

With respect to the above-described coordinate input apparatus 1A according to the first embodiment, for the purpose of arranging the optical movement detection device 2 between the bottom case 6A and the top cover 8A, the locking levers 9A are provided on the top cover 8A so that the optical movement detection device 2 is supported movably in directions Z1 and Z2 by the locking levers 9A.

By contrast, as for the coordinate input apparatus 1B according to the present second embodiment, locking levers 9B are formed upright on a bottom case 6B. The optical movement detection device 2 is so supported by the locking levers 9B that the optical movement detection device 2 is movable by a predetermined amount in directions Z1 and Z2.

Hook portions formed at upper ends (in direction Z2) of the locking levers 9B engage upper edges of the body portion 13 so as to restrict the optical movement detection device 2 from moving further beyond the engaging position in direction Z2. Additionally, the locking levers 9B can be formed easily, because the locking levers 9B are formed at the same time that the bottom case 6B is molded.

In the present second embodiment in which the locking levers 9B are formed on the bottom case 6B, the coordinate input apparatus 1B can also be miniaturized and thinned down, as in the first embodiment. Besides, through holes 33 are formed in the flexible substrate 11 provided on the bottom case 6B, in addition to the through hole 32. Whereas the projecting portion 7 passes through the through hole 32, the locking levers 9B pass through the through holes 33.

Next, a description will be given of a third embodiment according to the present invention.

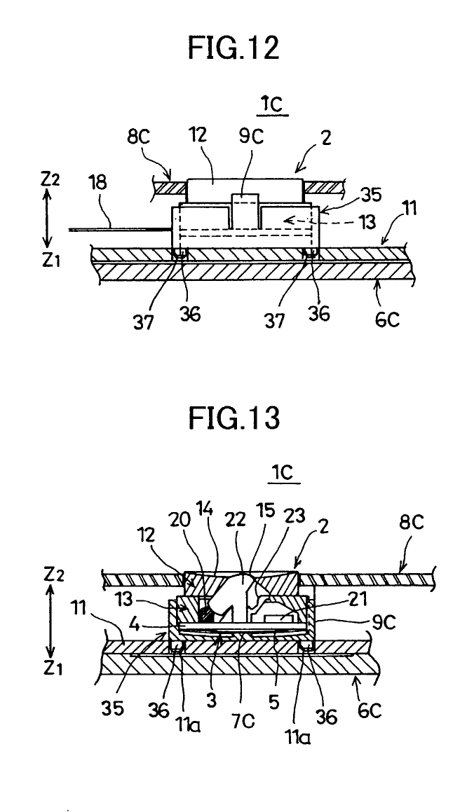

FIG. 11 to FIG. 13 illustrate a coordinate input apparatus 1C according to the third embodiment of the present invention. The coordinate input apparatus 1C according to the third embodiment is characterized in that the optical movement detection device 2 is supported by a supporting mechanism 35. The supporting mechanism 35 is a resinous molding, and has a rectangular form including a bottom. The optical movement detection device 2 is supported in the supporting mechanism 35 such that the optical movement detection device 2 is movable slightly in directions Z1 and Z2 in the figures.

Locking levers 9C are formed unitarily with the supporting mechanism 35. Hook portions formed at upper ends (in direction Z2) of the locking levers 9C engage upper edges of the body portion 13 so as to restrict the optical movement detection device 2 from moving further beyond the engaging position in direction Z2.

In addition, leg portions 36 are formed unitarily on a bottom surface of the supporting mechanism 35. The leg portions 36 are inserted into mounting holes 11a formed in the flexible substrate 11 so as to position the supporting mechanism 35. The supporting mechanism 35 is fixed to the flexible substrate 11 by using an adhesive, etc.

Further, a projecting portion 7C protruding toward direction Z2 in FIG. 13 is formed at a central position on an inner undersurface of the supporting mechanism 35. This projecting portion 7C is formed unitarily with the supporting mechanism 35. Therefore, the locking levers 9A and 9B need not be formed on the top covers 8A and 8B and the bottom cases 6A and 6B, as in the above-described embodiments. Accordingly, the housing 26 (a top cover 8C, a bottom case 6C) can be formed easily, and thus, a metal mold used for forming the housing 26 can be manufactured at a lower cost.

Additionally, in the coordinate input apparatus 1C according to the present third embodiment, the optical movement detection device 2 and the switch device 3 are mounted unitarily in the supporting mechanism 35. Accordingly, the coordinate input apparatus 1C can be mounted in the housing 26 simply by arranging the supporting mechanism 35 at a predetermined position. Therefore, positioning of the optical movement detection device 2 and the switch device 3, and positioning of the switch device 3 and the projecting portion 7C, become unnecessary; thus, the coordinate input apparatus 1C and the portable phone 25 can be assembled easily.

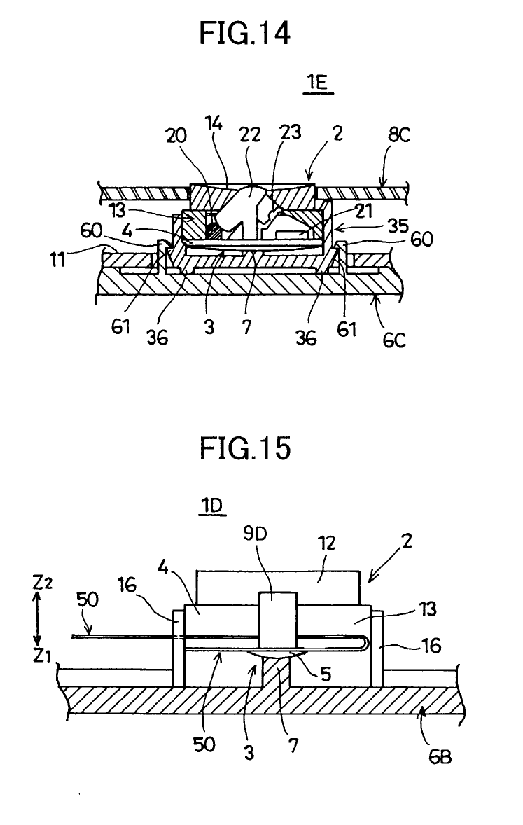

FIG. 14 illustrates a coordinate input apparatus 1E as a variation of the coordinate input apparatus 1C. With respect to the foregoing coordinate input apparatus 1C, the leg portions 36 formed on the bottom surface of the supporting mechanism 35 are fixed to the flexible substrate 11.

By contrast, as for the coordinate input apparatus 1E according to the present variation, overhangs 61 used for fixation are formed at outer peripheral side surfaces of the supporting mechanism 35, and hooks 60 are formed upright on the bottom case 6C. The hooks 60 engage the overhangs 61 so as to fix the supporting mechanism 35 to the bottom case 6C. As in the present variation, the supporting mechanism 35 may be fixed, not only to the flexible substrate 11, but also to the bottom case 6C. Additionally, although the present variation uses the overhangs 61 and the hooks 60 to fix the supporting mechanism 35 to the bottom case 6C, other means, such as screws, can be used to fix the supporting mechanism 35 to the bottom case 6C.

Next, a description will be given of a fourth embodiment according to the present invention.

FIG. 15 to FIG. 17 are illustrations used for explaining a coordinate input apparatus 1D according to the fourth embodiment of the present invention. The coordinate input apparatus 1D according to the fourth embodiment is characterized in that the light-emitting diode 20, the sensor 21 and the electronic components 39 are provided on a surface 50a of a flexible substrate 50, and that the contact-point member 5 and the switch electrodes 19A and 19B are provided on the surface 50a.

However, the light-emitting diode 20, the sensor 21 and the electronic components 39 have to be positioned at a side different from a side at which the contact-point member 5 and the switch electrodes 19A and 19B are positioned. Specifically, when the light-emitting diode 20, the sensor 21 and the electronic components 39 are positioned at a side in direction Z2, the contact-point member 5 and the switch electrodes 19A and 19B need to be positioned at a side in direction Z1. In the present fourth embodiment, the flexibly transformable flexible substrate 50 is used to realize this arrangement.

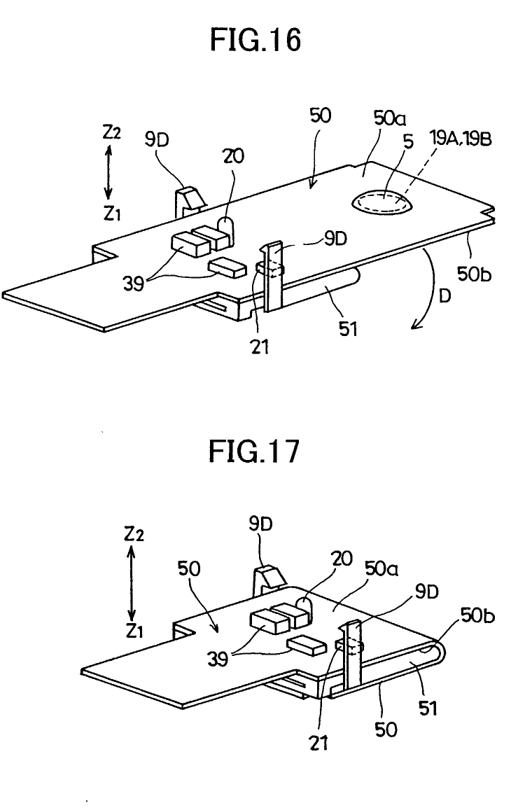

That is, even when the light-emitting diode 20, the sensor 21, the electronic components 39, the contact-point member 5 and the switch electrodes 19A and 19B are provided on the surface 50a, folding the flexible substrate 50 in a direction indicated by an arrow D shown in FIG. 16 enables the light-emitting diode 20, the sensor 21 and the electronic components 39 to be positioned at the side in direction Z2, and the contact-point member 5 and the switch electrodes 19A and 19B to be positioned at the side in direction Z1.

In the present fourth embodiment, a plate 51 is provided under the flexible substrate 50 so that the flexible substrate 50 is folded along an end of the plate 51. Thus, the flexible substrate 50 can be folded easily. Additionally, the plate 51 is provided with locking levers 9D used for supporting the optical movement detection device 2.

FIG. 17 shows the folded flexible substrate 50. As shown in FIG. 17, although the light-emitting diode 20, the sensor 21, the electronic components 39, the contact-point member 5 and the switch electrodes 19A and 19B are provided on the surface 50a of the flexible substrate 50, the light-emitting diode 20, the sensor 21 and the electronic components 39 are positioned opposite the contact-point member 5 and the switch electrodes 19A and 19B across the folded flexible substrate 50.

As described above, in the coordinate input apparatus 1D according to the present fourth embodiment, the light-emitting diode 20, the sensor 21 and the electronic components 39 constituting the optical movement detection device 2, and the contact-point member 5 and the switch electrodes 19A and 19B constituting the switch device 3 are provided on the same surface 50a of the flexible substrate 50. Accordingly, the coordinate input apparatus 1D can be assembled with ease.

Additionally, the flexible substrate 50 also functions as a wiring used for connecting the coordinate input apparatus 1D with an external apparatus or circuit; therefore, leading wires need not be provided aside from the flexible substrate 50. This decreases a number of components provided in the coordinate input apparatus 1D, and reduces costs required for manufacturing the coordinate input apparatus 1D.

Besides, although the coordinate input apparatuses 1A to 1E are used in the portable phone 25 in the above-described embodiments, the present invention is not limitedly applicable to the portable phone 25 alone, but is widely applicable as a pointing device of other electronic apparatuses (such as portable information tools).

The present invention is not limited to the specifically disclosed embodiments, and variations and modifications may be made without departing from the scope of the present invention.

The present application is based on Japanese priority application No. 2001-225991 filed on Jul. 26, 2001, the entire contents of which are hereby incorporated by reference.

What is claimed is:

1. A coordinate input apparatus comprising:
an optical movement detection device projecting a light on a detection object moving on an input portion, and receiving the light reflected from said detection object so as to generate a move signal according to said light reflected from said detection object, the move signal including moving direction information and moving distance information of said detection object; and
a switch device switching on and off by said optical movement detection device being displaced by said input portion being pressed.

2. The coordinate input apparatus as claimed in claim 1, wherein said optical movement detection device and said switch device are formed on a same surface of a flexible substrate, and
said flexible substrate is folded at a position between said optical movement detection device and said switch device so that said optical movement detection device and said switch device face outward respectively, and oppose each other with said flexible substrate therebetween.

3. The coordinate input apparatus as claimed in claim 1, wherein said switch device comprises:
a switch member provided in a vicinity of a bottom surface of said optical movement detection device;
a contact-point member provided opposite electrodes formed on said switch member, the contact-point member being elastically transformable between a first position contacting said electrodes and a second position away from said electrodes; and
a pressing member provided at a position opposing said contact-point member so as to engage said contact-point member and press said contact-point member toward said first position when said optical movement detection device is displaced.

4. The coordinate input apparatus as claimed in claim 1, wherein said optical movement detection device comprises:
a light source emitting a light;
a sensor unit receiving the light reflected from said detection object so as to generate said move signal; and
an optical unit projecting said light emitted from said light source on said detection object moving on said input portion, and leading said light reflected from said detection object to said sensor unit.

5. The coordinate input apparatus as claimed in claim 1, further comprising:
a first member accommodating said input portion such that said input portion is exposed outwardly; and
a second member provided opposite said first member,
wherein said optical movement detection device and said switch device are provided between said first member and said second member, and said optical movement detection device is provided movably on said first member.

6. The coordinate input apparatus as claimed in claim 1, further comprising:
a first member accommodating said input portion such that said input portion is exposed outwardly; and
a second member provided opposite said first member,
wherein said optical movement detection device and said switch device are provided between said first member and said second member, and said optical movement detection device is provided movably on said second member.

7. The coordinate input apparatus as claimed in claim 1, further comprising:
a first member accommodating said input portion such that said input portion is exposed outwardly;
a second member provided opposite said first member so that said optical movement detection device and said switch device are provided between said first member and said second member, the second member having a circuit substrate provided thereon; and
a supporting mechanism provided on at least one of said second member and said circuit substrate so as to movably support said optical movement detection device.

8. A portable phone communicating by wireless, the portable phone comprising:
a coordinate input apparatus including:
an optical movement detection device projecting a light on a detection object moving on an input portion, and receiving the light reflected from said detection object so as to generate a move signal according to said light reflected from said detection object, the move signal including moving direction information and moving distance information of said detection object; and
a switch device switching on and off by said optical movement detection device being displaced by said input portion being pressed.
